(19) United States
(12) Patent Application Publication
(10) Pub. No.: US 2002/0075902 A1
(43) Pub. Date: Jun. 20, 2002

(54) Optimum overhead framing techniques for ADSL DMT modems

(76) Inventors: Syed Aun Abbas, Fremont, CA (US); Guozhu Long, Newark, CA (US)

Correspondence Address: FENWICK & WEST LLP, TWO PALO ALTO SQUARE, PALO ALTO, CA, 94306, US

(21) Appl. No.: 09/960,842

(22) Filed: Sep. 21, 2001

Related U.S. Application Data
(60) Provisional application No. 60/240,001, filed on Oct. 12, 2000.
(60) Provisional application No. 60/239,398, filed on Oct. 5, 2000.
(60) Provisional application No. 60/235,150, filed on Sep. 22, 2000.

(51) Int. Cl. H04J 3/26

(52) U.S. Cl. 370/474; 370/522; 370/282

(57) ABSTRACT

Techniques described herein can be used at least by transceiver systems based on G.992.1 and G.992.2 to allocate management/control information for transmission using DMT symbols. In one embodiment of the present invention, a separate management/control information channel is allocated independent of interleaved and fast paths. Advantageously, if management and overhead information need to be transmitted quickly or often, valuable data payload bandwidth of the fast path is not used and the slow transmission of the interleaved path is avoided. In another embodiment of the present invention, a management/control information channel may be allocated independent of interleaved and fast paths, but distinct path specific sync bytes may be allocated to one or both of the interleaved and fast paths to carry path specific information.

### CROSS REFERENCE TO RELATED APPLICATIONS

This application claims priority from U.S. Provisional Patent Application Serial No. 60/240,001 filed Oct. 12, 2000, U.S. Provisional Patent Application Serial No. 60/239,398 filed Oct. 5, 2000, and U.S. Provisional Patent Application Serial No. 60/235,150 filed Sep. 22, 2000, which are all incorporated by reference in their entirety.

### FIELD OF THE INVENTION

The present invention relates generally to the field of communications systems and more specifically to overhead information multiplexing in asymmetric digital subscriber line modems.

### RELATED ART

The Telecommunications Standards Section of the International Telecommunication Union (ITU-T) develops recommendations to facilitate the interoperation of telecommunication networks. Two of these recommendations are designated as G.992.1 (sometimes referred to as G.dmt) and G.992.2 (sometimes referred to as G.lite), both of which are incorporated herein by reference in their entirety. Recommendation G.992.1 refers to an asymmetric digital subscriber line (ADSL) transceiver that is an ADSL industry standard for typical network access at data rates up to 8.192 Mbit/s downstream and 640 kbit/s upstream. Recommendation G.992.2, on the other hand, refers to an ADSL transceiver that is a lower data rate version of a G.992.1 ADSL transceiver. Data rates up to 1.5 Mbit/s in the downstream direction and 512 kbit/s upstream are typical with this standard. Factors such as the electrical characteristics of the customer's equipment, the distance between the subscriber and central office, and the error rate allowed all contribute to the data rate of G992.1 and G992.2 transceivers. For example, FIG. 1A depicts a pair of ADSL transceivers between a network operator end (ATU-C) and a customer end (ATU-R) in, for example, G.992.1 and G.992.2 compliant systems.

G.992.1 and G.992.2 transceivers both employ discrete multi-tone (DMT) technology. DMT is a form of multicarrier modulation in which the spectrum of the input signal is spread over numerous bands, also referred to as sub-channels. Each sub-channel is modulated to some carrier frequency. By working with a large number of carriers rather than a single carrier, the available channel capacity is maximized thereby optimizing performance of the transmission. A DMT symbol is the basic unit of information transmitted by an ADSL transceiver.

Both G.992.1 and G.992.2 further describe a DMT ADSL system data framing that is designed to provide a fixed overhead per DMT symbol. Overhead includes information about the transceiver pair and performance management. Consequently, G.992.1 and G.992.2 allocate a fixed bandwidth for overhead. One drawback with fixed overhead bandwidth is that bandwidth which could have been used for data transfer is allocated for overhead, even if the entire allocated overhead bandwidth is not used. In cases where the overhead bandwidth is transmitted using an “interleaved” or “slow” path, overhead information may not be transferred quickly enough. Further, in some implementations of G.992.1 and G.992, overhead bytes are allocated for various types of transmissions and so, when more overhead bandwidth is needed for a specific type of overhead transmission, that bandwidth is not available.

What is needed, therefore, are optimum overhead framing techniques for ADSL modems that minimize the use of bandwidth used for overhead information transfer and provide flexibility to repartition the bandwidth available to overhead information, among specific portions of overhead information.

### SUMMARY

One embodiment of the present invention includes a method of allocating overhead within DMT ADSL frames, where the method includes allocating an interleaved data path; allocating a fast data path; allocating a path for overhead and management information independent of the fast and interleaved data paths; and within a DMT ADSL frame, combining the overhead and management information with the interleaved and fast data paths.

One embodiment of the present invention includes a method of allocating overhead within DMT ADSL frames, where the method includes: allocating an interleaved data path; allocating first sync bytes among the interleaved data path; allocating a fast data path; allocating second sync bytes among the fast data path; allocating a path for overhead and management information independent of the fast and interleaved data paths; and within a DMT ADSL frame, combining the overhead and management information with the interleaved and fast data paths.

Advantageously, a dedicated overhead and management information channel is provided so that if management and overhead information needs to be transmitted quickly or often, valuable data payload bandwidth of the fast path is not used and the slow transmission of the interleaved path is avoided.

Various embodiments of the present invention will be more fully understood in light of the following detailed description taken together with the accompanying drawings. It should be noted that the language used in the specification has been principally selected for readability and instructional purposes and not to limit the scope of the inventive subject matter.

### BRIEF DESCRIPTION OF THE DRAWINGS

FIG. 1A depicts a pair of ADSL transceivers.

FIG. 1B is a block diagram of an ADSL transmitter that maybe configured in accordance with embodiments of the present invention.

FIG. 2A depicts a suitable overhead byte and field allocations used in techniques to allocate management/control information for transmission using DMT symbols in accordance with an embodiment of the present invention.

FIG. 2B depicts suitable overhead byte and field allocations used in techniques to allocate management/control information for transmission using DMT symbols in accordance with another embodiment of the present invention.

FIG. 3A depicts a format of a management/control information block 500A in accordance with another embodiment of the present invention.

FIG. 3B depicts a format of a management/control information block 500B in accordance with another embodiment of the present invention.

FIG. 3C depicts a format of a management/control information block 500C in accordance with another embodiment of the present invention.

FIG. 4 depicts a process for dynamically allocating the available overhead bytes in accordance with an embodiment of the present invention.

Note that use of the same reference numbers in different figures indicates the same or like elements.

### DETAILED DESCRIPTION

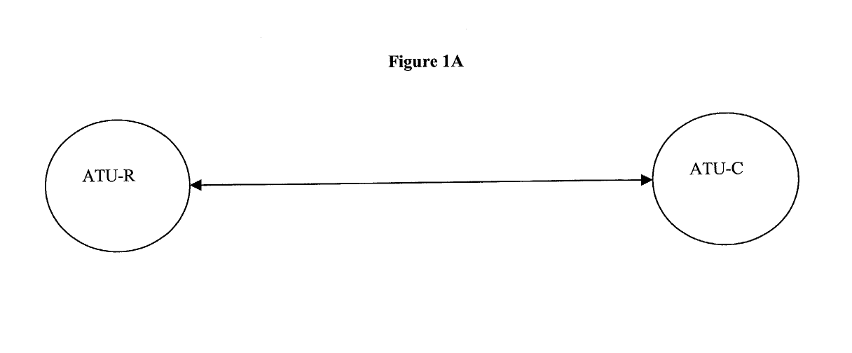

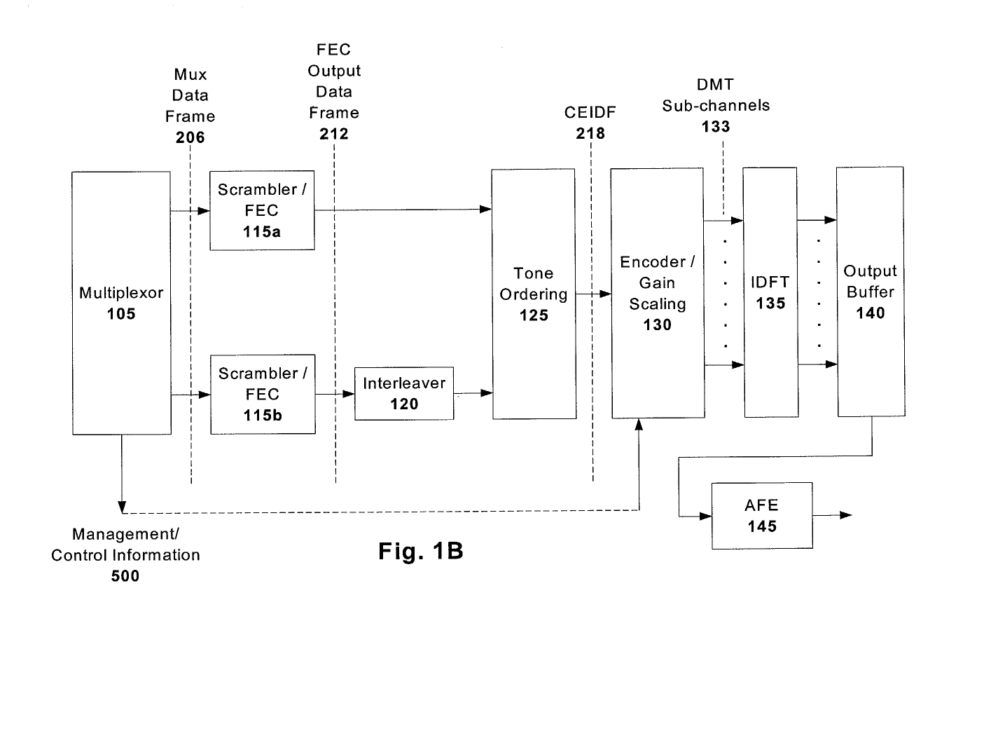

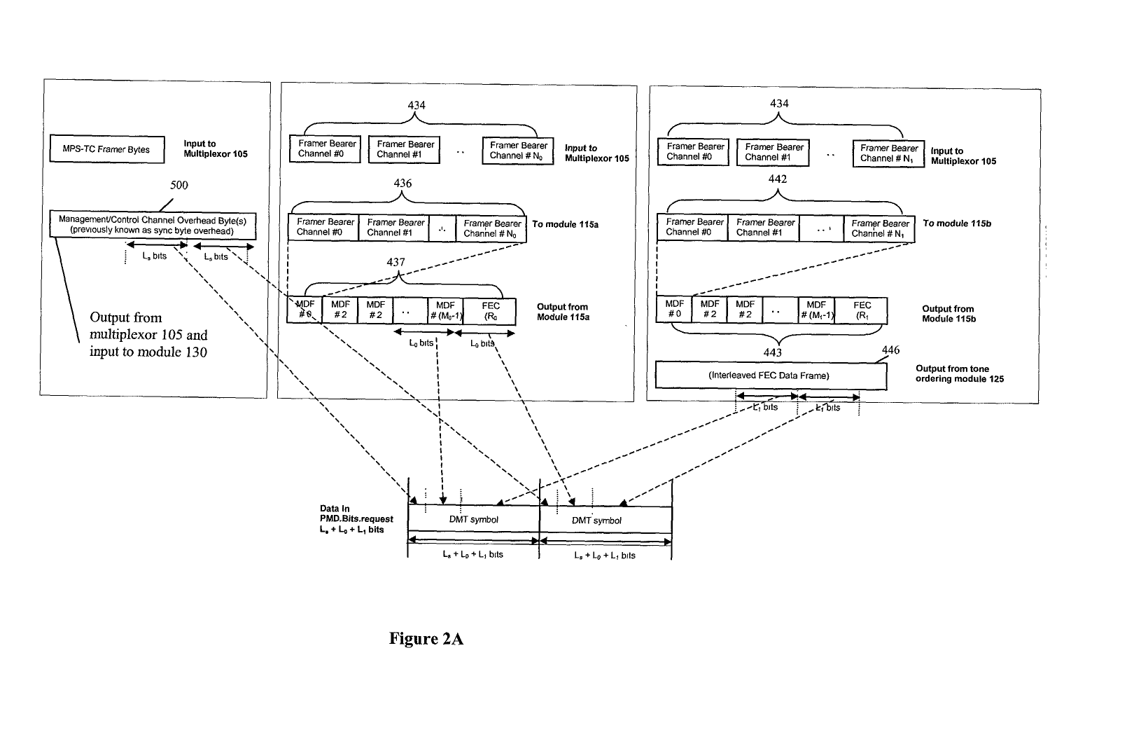

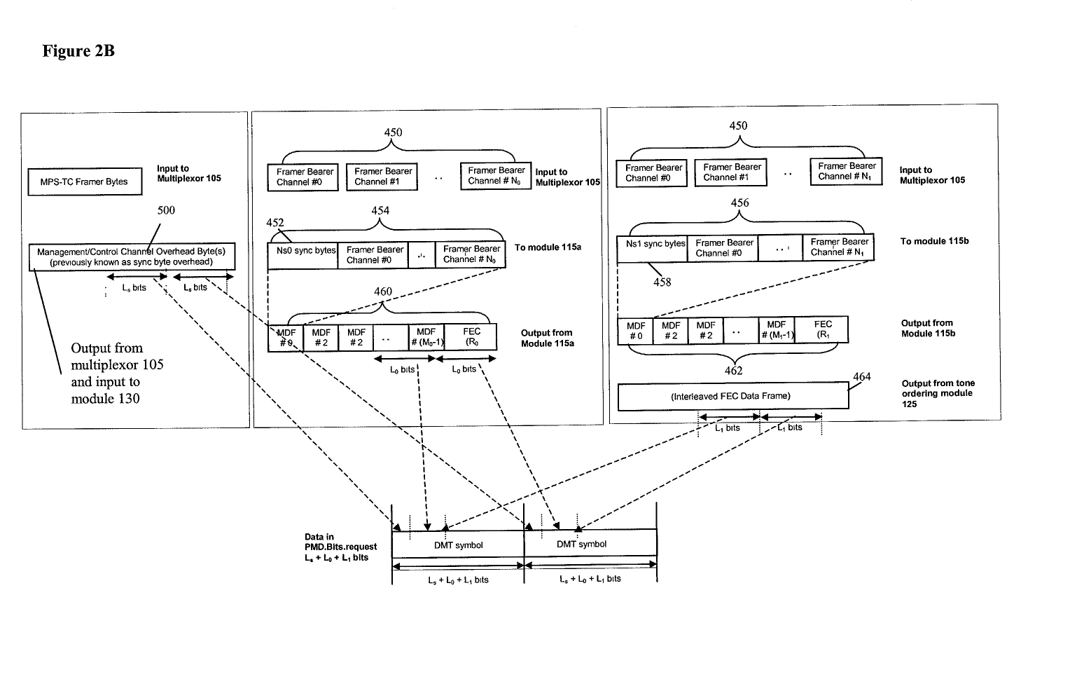

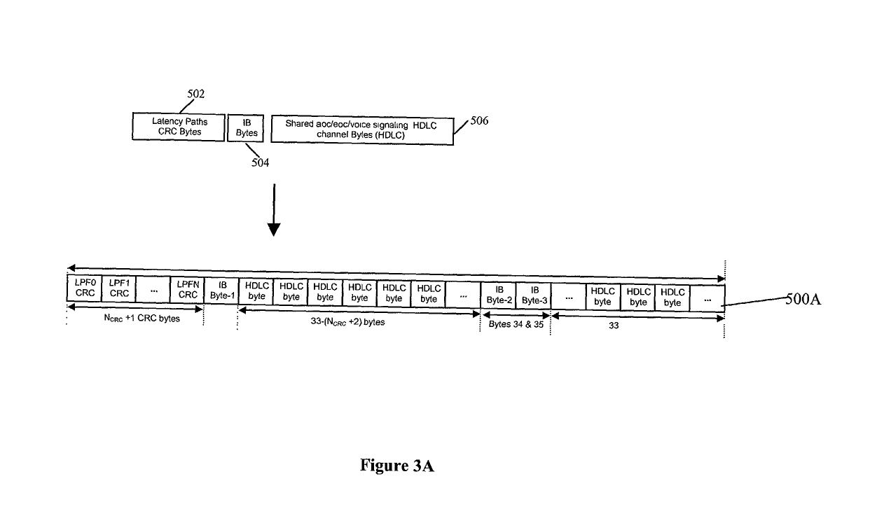

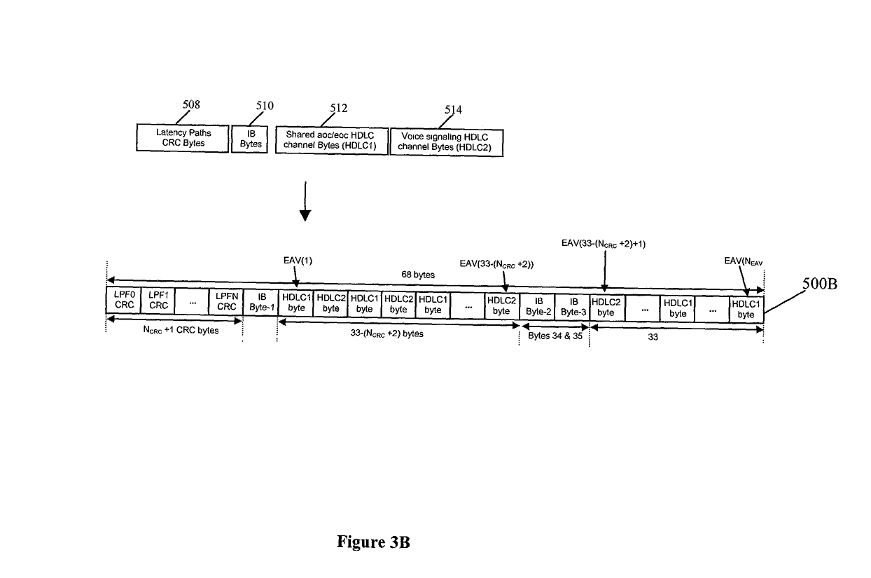

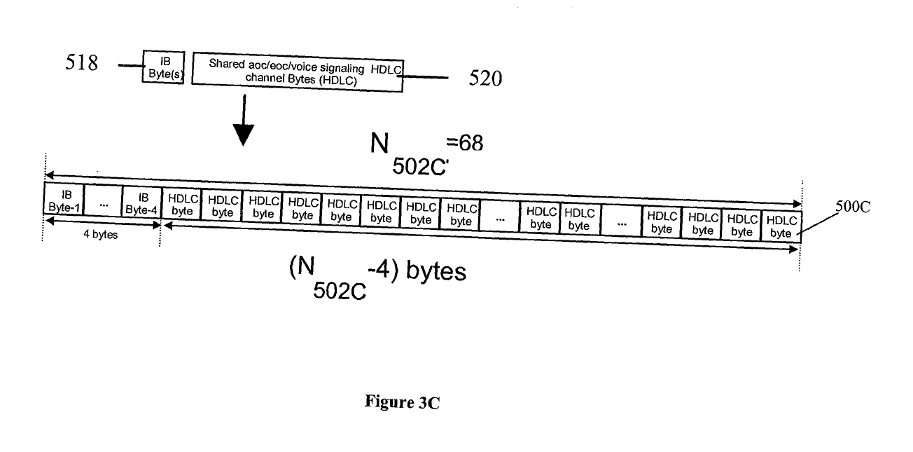

FIG. 1B is a block diagram of an ADSL transmitter that may be configured in accordance with embodiments of the present invention described with respect to FIGS. 2A and 2B and FIGS. 3A-3C. FIG. 1B merely illustrates an example of an ADSL transmitter and can be replaced with other ADSL transmitters. For example, other embodiments of the transmitter may include modules not shown in the Figure (e.g., an amplifier, line driver, anti-aliasing filter, and hybrid circuitry). Likewise, other embodiments of the transmitter may not include some of the modules shown (e.g., FEC module or interleaving module) on one of the latency paths. The transmitter components may be implemented in hardware, software, firmware or any combination thereof. For example, each of the components shown in FIG. 1B may be implemented as one or more application specific integrated circuits. Likewise, the components may be implemented as a set (or sets) of instructions running on one or more digital signal processors. Numerous embodiments and configurations will be apparent in light of this disclosure. For example, a suitable embodiment of the transmitter of FIG. 1B is described in U.S. patent application Ser. No. 09/846,883, entitled “Framing Techniques for ADSL Systems”, filed May 1, 2001, which is incorporated herein by reference in its entirety.

The transmitter of FIG. 1B includes a multiplexor module 105, scrambler and forward error correction (FEC) modules 115a and 115b, an interleaver module 120, a tone ordering module 125, an encoder and gain scaling module 130, an inverse discrete Fourier transform (IDFT) module 135, a output buffer 140, and an analog front end 145. Generally, the transmitter illustrated is based on a model for facilitating understanding of transmitter function in accordance with ITU Recommendations G.992.1 and G.992.2 (collectively referred to as ADSL standards).

The transmitter shown in FIG. 1B may be deployed in either the upstream or downstream direction. The multiplexor module 105 multiplexes requisite overhead (e.g., CRC bits, indicator bits, eoc and aoc messages are carried over what is commonly referred to as a sync byte) with the user payload data from a system interface (e.g., ATM or STM). Typically, there are two latency paths in the transmitter (e.g., a fast path and an interleaved path). Note, however, that alternative embodiments may include more than two latency paths. Additional paths may optionally include either or both an FEC module and an interleaver module. In general, a fast latency path (e.g., including scrambler/FEC module 115a) may be configured to provide lower latency than an interleaved path. An interleaved path (e.g., including scrambler/FEC module 115b and interleaver module 120), on the other hand, provides protection against burst errors due to the transmitted signal clipping or impulse noise at the cost of greater latency.

In the embodiment shown, the mux data frames provided by multiplexor 105 to each latency path are subjected to scrambling and forward error correction coding (e.g., 115a and b). In addition, the mux data frames provided by multiplexor 105 to the interleaved latency path are subjected to an interleaver function (e.g., 120). The two data streams may then be combined into a data symbol that is input to the constellation encoder (e.g., 130). Before a data symbol is mapped to the sub-carrier constellations, the sub-carriers may be appropriately tone ordered (e.g., 125). After constellation encoding, the data is modulated (e.g., 135), buffered (e.g., 140), and converted (e.g., 145) to its analog equivalent to facilitate transmission across the transmission loop.

Because of the addition of FEC redundancy bytes and data interleaving, the various intermediate data frames (bit-level data prior to constellation encoding) have different structure at three reference points of the transmitter. These reference points are shown in FIG. 1B and include 206 (mux data frame), 212 (FEC output data frame), and 218 (constellation encoder input data frame). Generally, the present invention provides a framing technique and framing parameters that result in a certain order of sync, payload data and the RS codeword redundancy bytes to achieve programmable fixed overhead efficient framing that allows seamless rate changes.

Components

The multiplexor module 105 multiplexes the user payload data bytes and overhead bytes (e.g., sync bytes). The multiplexor module 105 may include, for example, a multiplexor for each latency path and separate buffers (e.g., a fast buffer and an interleaved buffer) to store the multiplexed data for each corresponding latency path. In the embodiment shown, the multiplexor on each of the latency paths (whether downstream or upstream) has a mux data frame rate that is either synchronized to a 4 kbps ADSL DMT symbol rate or to its known fraction or a multiple through a multiplying factor.

In the embodiment shown, a cyclic redundancy check (CRC) is performed on the multiplexed data for each latency path. Generally, the CRC bits of a particular latency path are carried in a sync byte included in each mux data frame assigned to that latency path after every 68 DMT symbols. Remaining sync bytes that are transmitted over 68 DMT symbols (e.g., an ADSL superframe) carry other overhead related information (e.g., indicator bits, eoc and aoc messages). The multiplexor module 105 outputs mux data frames 206.

For the sake of clarity, note that current ADSL standards define a superframe structure. Each superframe is composed of a number of data frames (e.g., 68 data frames numbered 0 through 67). These data frames are encoded and modulated into DMT symbols. Each DMT symbol is followed by a synchronization symbol. In general, such synchronization symbols carry no user or overhead bit-level data and are inserted by the modulator (e.g., 135) to establish superframe boundaries. From the bit-level and user data perspective, the DMT symbol rate is 4000 baud resulting in a period equal to 0.25 milliseconds (in accordance with ADSL standards). However, in order to allow for the insertion of the synchronization symbol, the actual transmitted DMT symbol rate is 69/68 times 4,000 baud.

In the scrambler and FEC modules 115a and 115b, the scrambler (e.g. when present and operational) operates on the output data buffer of each mux data frame 206 in order to randomize the data pattern as is conventionally done. Such randomizing is for optimizing the transmission performance. Scrambling also minimizes the possibility of repetitive data patterns. Generally, FEC is based on Reed-Solomon (RS) coding. The size (in bytes) of a resulting RS codeword is N_{FEC}=K+R, where the number of check bytes R and codeword size N_{FEC} vary depending on the number of bits assigned to each latency path and the latency requirements associated with each path. The scrambler and FEC modules 115 output the RS codewords, which form the FEC output data frames 212.

The interleaver module 120 performs a conventional interleaving function on the FEC output data frames 212. In one embodiment, the FEC output data frames 212 are convolutionally interleaved in accordance with ADSL standards to a specified interleave depth. Generally, the interleaving process delays each byte of a given FEC output data frame 212 by a different amount. This results in the constellation encoder input data frames 218 containing bytes from a number of different FEC output data frames 212. Given a convolutional interleaving algorithm and the interleaving depths (e.g., powers of 2), the output bytes from the interleaver always occupy distinct time slots when the RS codeword size (N) is odd. When N is an even number of bytes, a dummy byte can be added at the beginning of the RS codeword at the input to the interleaver. The resultant odd-length RS codeword is then convolutionally interleaved. The dummy byte is then removed from the output of the interleaver.

The tone ordering module 125 provides a tone ordering algorithm (e.g., vendor specified) to reduce the errors related to clipping caused by the digital-to-analog converter (not shown) of the transmitter. In general, the numbers of bits and the relative gains to be used for every tone are predetermined by the receiver (e.g., by conventional bitloading assignment techniques) and provided to the transmitter. These bit-gain pairs are typically stored in ascending order of frequency (e.g., as designated by tone number) in a bit and gain table. “Tone-ordered” encoding can then be performed, where bits from a fast path are assigned to the tones with the smallest bit assignment, and bits from an interleaved path are assigned to the remaining tones. As is known in the art and illustrated in ADSL standards, tone ordering and bit extraction may be performed with and without trellis coding. Note that because the data from the fast path is not interleaved, the constellation encoder input data frame 218 is identical to the corresponding FEC output data frame 212 (if fast path is the only latency path used).

The encoder and gain scaling module 130, which can be implemented with or without trellis coding, receives the constellation encoder input data frames 218 and encodes them as signal points in signal constellations based on a given tone ordering. The encoder and gain scaling module 130 may further include a convolutional encoder module for obtaining the coding gain. In one embodiment, for each sub-channel, QAM modulation is used where each constellation signal point has an in-phase component and a quadrature component. Depending on the constellation size of each DMT sub-channel, each sub-carrier carries multiple bits. For example, 64-QAM has 64 points in the constellation. This means that a sub-channel can carry six binary bits. A larger constellation size carries more bits per symbol. Sub-channels can have different constellation sizes. The total number of bits transmitted is the sum of the number of bits transmitted by each sub-channel. A number of sub-channels 133 (e.g., 255 for downstream, 31 for upstream with appropriate gain scaling) are provided by the encoder and gain scaling module 130 to the IDFT module 135.

The inverse discrete Fourier transform (IDFT) module 135 modulates the constellations (e.g., QAM constellations) output by the encoder and gain scaling module 130 on to the available transmission DMT sub-channels and combines all the sub-channels together for transmission. The output buffer 140 stores the modulated samples for transmission. The analog front end (AFE) 145 converts the samples to analog signals, which are then filtered, amplified and coupled to the transmission line. Note that the IDFT module 135, the output buffer 140 and the analog front end 145 may be implemented in conventional technology.

Overhead Channel Management

Embodiments of the present invention described herein can be used at least by transceiver systems based on G.992.1 and G.992.2 to allocate management and control information for transmission using DMT symbols. FIGS. 2A and 2B depict suitable overhead byte and field allocations used to allocate management/control information for transmission using DMT symbols in accordance with embodiments of the present invention. The examples provided in FIGS. 2A and 2B show outputs by each of multiplexor 105, module 115a, module 115b, the interleaver 120, tone ordering module 125, and the transmitter of FIG. 1B (as DMT symbols). Overhead byte allocations in accordance with examples provided in FIGS. 2A, 2B and FIGS. 3A-3C may be suitably implemented by using the transmitter described with respect to FIG. 1B (or another transmitter) in combination with software instructions executed by a digital signal processing device or other central processing unit, firmware, and/or hardware.

FIG. 2A

FIG. 2A depicts suitable overhead byte and field allocations used in techniques to allocate management/control information for transmission using DMT symbols in accordance with an embodiment of the present invention. In FIG. 2A, framer bearer channels 434 are input into multiplexor 105. Framer bearer channels 434 include, for example, data, voice, and video. Multiplexor 105 outputs framer bearer channels 436 to module 115a (“fast path”) and outputs framer bearer channels 442 to module 115b (“interleaved path”). Module 115a allocates respective framer bearer channels 436 into respective FEC output data frames 437. The tones to be transmitted are ordered by module 125. Module 115a transfers the FEC output data frames 437 to the encoder gain scaling module 130. Module 115b allocates respective framer bearer channels 442 into respective FEC output data frames 443. Interleaver 120 (FIG. 1B) is coupled to receive the FEC output data frames 443 from module 115b. Interleaver 120 interleaves FEC output data frames 443 from module 115b in a manner described earlier and outputs the interleaved FEC output data frames 443 to the encoder gain scaling module 130.

Management protocol specific transmission-convergence (MPS-TC) framer bytes are input into multiplexor 105. For example, MPS-TC includes conventional information such as eoc, aoc, loss of signal, remote defect indicator, and network timing reference signals as described in G.992.1 and G.992.2. Multiplexed bytes of the MPS-TC framer bytes (hereafter “management/control information 500”) are output from the multiplexor 105 and input into encoder/gain scaling 130. FIGS. 3A-3C depict example embodiments of the management/control information 500. Advantageously, in this embodiment, no sync bytes or overhead information are allocated for either of the interleaved or fast paths. Rather management and overhead information are reserved for transmission using the management/control information 500. Advantageously, if management and overhead information needs to be transmitted quickly or often, valuable data payload bandwidth of the fast path is not used and the slow transmission of the interleaved path is avoided. As described in more detail with respect to FIG. 3B, the contents of the management/control information path can be modified thereby to provide flexible rate repartitioning of certain types of management/control information.

The transmitter allocates among DMT symbols the following: Lₛ bits of management/control information 500, L₀ bits of the mux data frames (MDF) from the fast path (e.g., module 115a), and L₁ bits of the FEC output data frames from the slow path (e.g., module 115b). Values Lₛ, L₀ and L₁ are determined based on available bandwidth of the channel, and desired partitioning of this bandwidth between different latency paths.

FIG. 2B

FIG. 2B depicts suitable overhead byte and field allocations used in techniques to allocate management/control information for transmission using DMT symbols in accordance with an embodiment of the present invention. The embodiment of FIG. 2B is similar to that of FIG. 2A except that the interleaved and fast paths also transmit sync bytes thereby to transmit some of the overhead and management information suitable for transmission on these paths. One example of such overhead information is the latency path CRC information. Although it can also be sent as in FIG. 2A, sending sync bytes in the fast and interleaved paths may provide some implementation ease because, for example, fewer gates and control logic are needed.

In FIG. 2B, framer bearer channels 450 are input into multiplexor 105. Framer bearer channels 450 include, for example, data, voice, and video as well as channel management and overhead information. Multiplexor 105 transfers frames 454 and 456 to respective modules 115a and 115b. Modules 115a and 115b process respective fast and interleaved paths. In this embodiment, fast and interleaved paths include overhead and management information, which are depicted in FIG. 2B as respective Ns0 sync bytes 452 and Ns1 sync bytes 458. In this embodiment, sync bytes include path specific (e.g., fast or interleaved) information such as CRC over data path, FEC and ATM cells related information, if applicable.

Module 115a allocates frame 454 with Ns0 sync bytes 452 into FEC output data frames 460. The tones to be transmitted are ordered by module 125. Module 115a outputs the FEC output data frames 460 to the encoder/gain scaling module 130. Module 115b allocates frame 456 with Ns1 sync bytes 458 into FEC output data frames 462. Interleaver 120 is coupled to receive the FEC output data frames 462 from module 115b. Interleaver 120 interleaves FEC output data frames 462 from module 115b and outputs the interleaved FEC output data frames 462 to the encoder/gain scaling module 130.

FIG. 3A

FIG. 3A depicts a format of a management/control information 500 in block 500A. In accordance with an embodiment of the present invention, block 500A includes fields 502, 504 and 506. Field 502 may include latency path related CRC bytes. Field 504 may include indicator bit (IB) bytes. Field 506 may include aoc, eoc, voice signaling bytes, which are encapsulated and multiplexed in an HDLC (High Level Data Link Control) frame. Fields 502, 504, and 506 are multiplexed by multiplexor 105 into block 500A. Block 500A can be 68 bytes although the number of bytes can be varied. The length of the block 500A can be determined so that the rate of transfer of block 500A is as desired. The length of block 500A can also be set to be long enough to be spread evenly over 68 DMT symbols.

The number of bytes of fields 502 to 506 within block 500A may be fixed by the network administrator and communicated by and among the transmitter and receiver pairs such as that depicted in FIG. 1A. Exact positions of bytes of fields 502 to 506 within block 500A may be arbitrary.

FIG. 3B

FIG. 3B depicts a format of a management/control information block 500 in block 500B. In accordance with an embodiment of the present invention, block 500B includes fields 508, 510, 512, and 514. Field 508 may include latency paths related CRC bytes. Field 510 may include IB bytes. Field 512 may include aoc and eoc bytes encapsulated in an HDLC frame (hereafter HDLC1). Field 514 may include voice signaling bytes also encapsulated in a separate HDLC frame (hereafter HDLC2). Fields 508, 510, 512, and 514 are multiplexed by multiplexor 105 into block 500B.

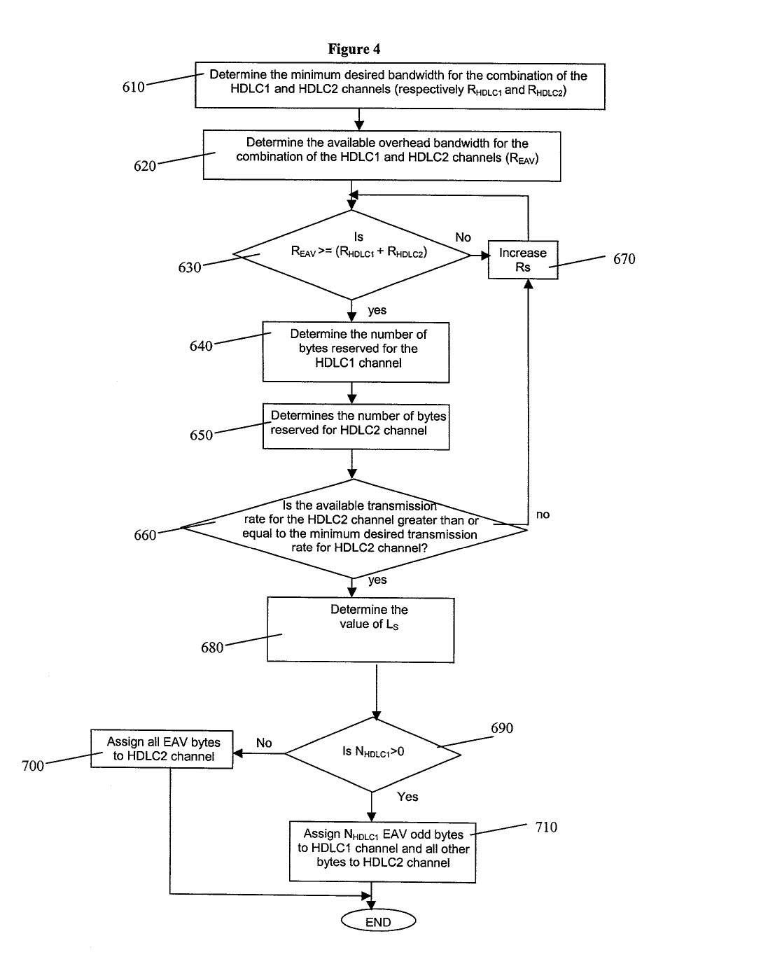

In one embodiment, block 500B is 68 bytes long. The length of block 500B can be set so to be long enough to be spread evenly over 68 DMT symbols. The number of bytes within block 500B is represented by N_{500B}=N_{CRC}+N_{IB}+N_{HDLC1}+N_{HDLC2}. In this embodiment, the number of CRC and IB bytes allocated within overhead information block are fixed based on number of latency paths. However, the number of bytes occupied by HDLC1 and HDLC2 within the overhead information block are dynamically allocable using the process described with respect to FIG. 4. The positions of the contents of fields 508, 510, 512, and 514 within block 500B are arbitrary.

FIG. 3C

FIG. 3C depicts a format of a management/control information block 500C in accordance with another embodiment of the present invention. Block 500C may include fields 518 and 520. Field 518 may include IB bytes whereas field 520 may include aoc, eoc and voice signaling bytes encapsulated in an HDLC frame. Fields 518 and 520 are multiplexed by multiplexor 105 into block 500C.

In one embodiment, block 500C is 68 bytes long. The length of block 500C can be set so to be long enough to be spread evenly over 68 DMT symbols. In this embodiment, the number of bytes of fields 518 and 520 are fixed. The positions of the contents of fields 518 and 520 within block 500C are arbitrary.

FIG. 4

FIG. 4 depicts a process for dynamically allocating the number of bytes available to the combination of HDLC1 and HDLC2 in the case of block 500B of FIG. 3B in accordance with an embodiment of the present invention. This process may be implemented by using the transmitter described with respect to FIG. 1B (or another transmitter) in combination with software instructions executed by a digital signal processing device or other central processing unit, firmware, and/or hardware. The following are a brief description of terms referenced in FIG. 4.

R_{S}=Transmission rate of the overhead channel (block 500B)

R_{EAV}=Available transmission rate for combination of the HDLC1 and HDLC2 channels

R_{HDLC1}=Minimum desired transmission rate for HDLC1 channel

R_{HDLC2}=Minimum desired transmission rate for HDLC2 channel

N_{HDLC1}—Number of bytes reserved for HDLC1 channel

N_{HDLC2}=Number of bytes reserved for HDLC2 channel

N_{EAV}=Number of bytes reserved for combination of HDLC1 and HDLC2 channels

N₅₀₀=Total number of bytes in MPS-TC frame

N_{CRC}=Number of bytes reserved for CRC

L_{S}—Number of bits per DMT symbols carrying bytes of the management/control information

(All of the foregoing transmission rates are in kbps.)

The following is a relationship of terms referenced in FIG. 4.

R_{EAV}=R_{S}*(N_{EAV}/N₅₀₀)

N_{HDLC1}=(R_{HDLC1}/R_{EAV})*N_{EAV}

N_{HDLC2}=N_{EAV}−NHDLC1

N_{EAV}=N₅₀₀−(N_{CRC}+4)

In action 610, the transmitter determines the minimum desired bandwidth allocated for the combination of the HDLC1 and HDLC2 channels. Variables R_{HDLC1} and R_{HDLC2} represent the minimum desired transmission/rate of respective HDLC1 and HDLC2 channels.

Action 620 follows action 610. In action 620, the transmitter determines the available overhead bandwidth for the combination of the HDLC1 and HDLC2 channels (variable R_{EAV}).

Action 630 follows action 620. In action 630, the transmitter determines whether the available overhead bandwidth for the combination of the HDLC1 and HDLC2 channels (variable R_{EAV}) is greater than the combination of minimum transmission/bandwidth for HDLC1 and HDLC2 channels. If so action 640 follows action 630: otherwise action 670 follows action 630.

In action 640, the transmitter determines the number of bytes reserved for the HDLC1 channel (N_{HDLC1}). In one embodiment, the value N_{HDLC1} is determined by the following equation:

N_{HDLC1}=(R_{HDLC1}/R_{EAV})*N_{EAV}

If N_{HDLC1} is not an integer, it is rounded up to the nearest integer.

Action 650 follows action 640. In action 650, the transmitter determines the number of bytes reserved for the HDLC2 channel (variable N_{HDLC2}). In one embodiment the variable N_{HDLC2} is determined by the following equation:

N_{HDLC2}=N_{EAV}−N_{HDLC1}

Action 660 follows action 650. In action 660, the transmitter determines whether the available transmission rate for the HDLC2 channel is greater than or equal to the minimum desired transmission rate for the HDLC2 channel. In one embodiment, the following equation is a suitable representation of action 660:

Is R_{EAV}(N_{HDLC2}/N_{EAV})>=R_{HDLC2}

If so, then action 680 follows action 660; otherwise action 670 follows action 660.

In action 670, the transmitter increases the transmission rate of the overhead channel (block 500B) (value Rs) thereby to increase the transmission rate available for transmission of the HDLC2 channel. For example, the transmitter may increase the transmission rate of the overhead channel (block 500B) (value Rs) by 4 kbps. A maximum transmission rate (Rs) can be the maximum total link bandwidth capacity.

Action 680 follows action 660. In action 680, the transmitter determines the number of bits per DMT symbol (L_{S}) to transfer the block 500B of FIG. 3C. Here Rs is assumed to be in kbps. For example, L_{S} can be determined by dividing Rs by the DMT symbol rate (e.g., 4 kbps).

Action 690 follows action 680. In action 690, the transmitter determines whether the number of bytes reserved for the HDLC1 channel (N_{HDLC1}) is greater than zero. If so, action 710 follows action 690; otherwise action 700 follows action 690.

In action 700, the transmitter assigns all EAV bytes (bytes reserved for the combination of HDLC1 and HDLC2) for use by HDLC2.

In action 710, the transmitter assigns, for example, N_{HDLC1} odd EAV bytes to HDLC1 and all other bytes to HDLC2.

The following is an example of results generated by FIG. 4. For example, assuming

R_{S}=68 kbps

N₅₀₀=68

N_{CRC}=1

R_{HDLC1}=4 kbps

R_{HDLC2}=59 kbps

Then, in accordance with one embodiment of the present invention, the following values will be determined:

R_{EAV}=63

N_{HDLC1}=4

N_{HDLC2}=59

N_{EAV}=63

Thereby, in accordance with action 710 of FIG. 4, the transmitter would assign EAV(1), EAV(3), EAV(5) and EAV(7) (FIG. 3B) for use by HDLC1 and the rest of the overhead channel bytes of the EAV bytes to the HDLC2.

### MODIFICATIONS

The foregoing description of the embodiments of the invention has been presented for the purposes of illustration and description. It is not intended to be exhaustive or to limit the invention to the precise form disclosed. Many modifications and variations are possible in light of the above teaching. For example, the transmission rate of the overhead channel (R_{S}) may vary or involve assigning even EAV bytes to HDLC1 and all other bytes to HDLC2. It is intended that the scope of the invention be limited not by this detailed description, but rather by the claims appended hereto.

What is claimed is:

1. A method of allocating overhead within DMT ADSL frames, the method comprising the acts of:
allocating an interleaved data path;
allocating a fast data path;
allocating a path for overhead and management information independent of the fast and interleaved data paths; and
within a DMT ADSL frame, combining the overhead and management information with the interleaved and fast data paths.

2. The method of claim 1, wherein the overhead and management information comprises interleaved data path related information.

3. The method of claim 1, wherein the overhead and management information comprises CRC bytes.

4. The method of claim 1, wherein the overhead and management information comprises IB bytes.

5. The method of claim 1, wherein the overhead and management information comprises aoc bytes.

6. The method of claim 1, wherein the overhead and management information comprises eoc bytes.

7. The method of claim 1, wherein the overhead and management information includes a first and second types of control information, wherein the bit rates of the first and second types of control information are programmable.

8. The method of claim 1 further comprising the acts of:
determining a number of bytes allocable to first and second portions of the overhead and management information; and
allocating the number of bytes for the first and second portions within the overhead and management information.

9. The method of claim 8, wherein the act of determining a number of bytes further comprises the acts of:
determining a minimum desired transmission rate for the combination of first and second portions;
determining the available overhead bandwidth for the combination of first and second portions; and
adjusting the available overhead bandwidth for the combination of first and second portions to be at least the desired transmission rate for the combination of first and second portions.

10. A method of allocating overhead within DMT ADSL frames, the method comprising the acts of:
allocating an interleaved data path;
allocating first sync bytes among the interleaved data path;
allocating a fast data path;
allocating second sync bytes among the fast data path;
allocating a path for overhead and management information independent of the fast and interleaved data paths; and
within a DMT ADSL frame, combining the overhead and management information with the interleaved and fast data paths.

11. The method of claim 10, wherein the first sync bytes includes overhead and management information related to the interleaved path.

12. The method of claim 10, wherein the second sync bytes includes overhead and management information related to the fast path.

13. The method of claim 10, wherein the overhead and management information comprises CRC bytes.

14. The method of claim 10, wherein the overhead and management information comprises IB bytes.

15. The method of claim 10, wherein the overhead and management information comprises aoc bytes.

16. The method of claim 10, wherein the overhead and management information comprises eoc bytes.

17. The method of claim 10, wherein the overhead and management information comprises a first and second types of control information, wherein the bit rates of the first and second types of control information are programmable.

18. The method of claim 10 further comprising the acts of:
determining a number of bytes allocable to first and second portions of the overhead and management information; and
allocating the number of bytes for the first and second portions within the overhead and management information.

19. The method of claim 18, wherein the act of determining a number of bytes further comprises the acts of:
determining a minimum desired transmission rate for the combination of first and second portions;
determining the available overhead bandwidth for the combination of first and second portions; and
adjusting the available overhead bandwidth for the combination of first and second portions to be at least the desired transmission rate for the combination of first and second portions.
